(19) United States
(12) Patent Application Publication
(10) Pub. No.: US 2006/0200286 A1
(43) Pub. Date: Sep. 7, 2006

(54) Mileage logging apparatus

(76) Inventors: Hiroyuki S. Kumagai, Boulder Creek, CA (US); Scott E. Christa, Santa Cruz, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/317,291

(22) Filed: Dec. 23, 2005

Related U.S. Application Data
(60) Provisional application No. 60/639,851, filed on Dec. 27, 2004.

(51) Int. Cl. G06F 19/00

(52) U.S. Cl. 701/35; 701/1

(57) ABSTRACT

A system and a method for a mileage (or other distance measurement) logging apparatus (or portable mileage logger) is configured as an electronic device, which keeps track of the vehicle's mileage. The mileage logger is independent of the vehicle's electrical and sensor systems, although it may also be configured to tap a vehicle's power connection. The mileage logger is configured for portability. Hence, it can be transferred from one vehicle to another and removed from the vehicle without the need for disabling and re-wiring. Moreover, the mileage logger may be configured with input/output ports to connect with a personal computer to download data from the apparatus. Alternative embodiments of the mileage logger may also be configured to include wireless network capabilities with an electronic mail protocol that allows for automatic wireless transmission of e-mailing capability to a user's computer, utilizing wireless network connections.

### CROSS REFERENCE TO RELATED APPLICATIONS

This application claims a benefit of, and priority under 35 USC § 119(e) to, U.S. Provisional Patent Application No. 60/639,851, titled “Mileage Logging Apparatus”, the contents of which are herein incorporated by reference.

### BACKGROUND OF THE INVENTION

1. Field of the Invention

The present invention generally relates to the field of mileage tracking of vehicles.

2. Description of the Related Art

There are many instances where one wants to keep track of vehicle usage and keep a written record. For example, mileage logs help identify vehicle conditions to help maintain or service a vehicle. In another example, employers may require the travel (or mileage) log when their employees are on official business travel. Similarly, the U.S. Internal Revenue Service (IRS) requires self-employed workers to keep a mileage log for tax deduction purposes when personal vehicles are used for business use.

Currently, mileage logs are typically maintained by manually writing a journal entry reflecting an odometer reading of a vehicle at a particular point in time. Such tasks are tedious, and often result in inaccurate mileage logs because of a lack of discipline necessary to keep an accurate log. The resulting downsides of inaccurate mileage logs include less accurate data relating to vehicle service and maintenance or financial loss in the form of tax deduction disallowance by the IRS of an entire annual business expense of a personal vehicle. Therefore, there is a need for a more accurate and reliable mileage tracking apparatus.

### SUMMARY OF THE INVENTION

The present invention includes a system and a method for a mileage (or other distance measurement, e.g., kilometers) logging apparatus (or portable mileage logger). In one embodiment, the mileage logger is configured as a small electronic device, which keeps track of the vehicle's mileage. The mileage logger is independent of the vehicle's electrical and sensor systems, although it may also be configured to tap a vehicle's power and/or sensor system.

The mileage logger is configured for portability. Hence, it can be transferred from one vehicle to another and removed from the vehicle without the need for disabling and re-wiring. Moreover, the mileage logger may be configured with input/output ports, e.g., a USB port or IEEE 1394 port, to connect with a personal computer to download data from the apparatus.

Alternative embodiments of the mileage logger may also be configured to include wireless network capabilities, e.g., IEEE 802.11a, b, g, or n, IEEE 802.16, or general product radio service (GPRS) with an electronic mail protocol that allows for automatic wireless transmission of e-mailing capability to a user's computer, utilizing wireless network connections. Further, the portable mileage logger may be configured to include a hardwired and/or software user interface that allows for use in multiple configurations, for example, between business and personal use modes when the personal vehicle is in use as well as between two or more vehicles.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The invention has other advantages and features which will be more readily apparent from the following detailed description of the invention and the appended claims, when taken in conjunction with the accompanying drawings, in which:

Figure (FIG.) 1 illustrates an example of one embodiment of a mileage tracking apparatus in accordance with the present invention.

FIG. 2 illustrates one embodiment of a functional block diagram of a mileage tracking apparatus in accordance with the present invention.

FIG. 3 shows one embodiment of a process for in-vehicle operation of a mileage tracking apparatus with a “logging enabled” key such as “business”/“personal” buttons in accordance with the present invention.

FIG. 4 illustrates one embodiment of a distance computing module in accordance with the present invention.

### DETAILED DESCRIPTION OF THE PREFERRED EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Architectural Overview

The present invention includes a mileage (or other distance measurement, e.g., kilometers) tracking apparatus that is configured to track of the vehicle mileage. In one embodiment, the mileage tracking apparatus is configured as an electronic device. Further, the electronic device may be configured for portability and may be configured independent of vehicle electronics. The electronic device may be battery powered, although it may also be configured to plug into a vehicle's power port (e.g., a cigarette lighter) to draw power for it.

Referring to FIG. 1, illustrated is an example of one embodiment of a mileage tracking (or logging) apparatus (or device) 110 in accordance with the present invention. The mileage tracking apparatus 110 includes a housing 115 and a vehicle power adapter 120. The housing 115 includes a display window 125 and one or more selection buttons, e.g., 130a, b (generally 130). The housing 115 also includes an interface port (not shown) 135. The display window 125 may be a display such as an LCD or plasma display and is used to display text, images and the like. The one or more selection buttons 130 may be any button that allows selection such as a switch, membrane, jog dial or the like. The selection may include selection of a director, e.g., navigation, or an item, e.g., select a link or function.

The selection buttons 130 can also work in both modes, navigation and select depending on a particular activity. The selection buttons 130 can also be configured to switch between modes, e.g., personal (e.g., record personal related information) or business (e.g., to record business related information). The interface 135 is any interface that allows communication with another device, e.g., a personal computer. Examples of an interface 135 include a universal serial bus (USB) interface, an IEEE-1394 interface, an infrared interface, an IEEE 802.11a, b, g, or n interface or a Bluetooth interface.

In one embodiment, the housing 115 is configured to be portable, e.g., handheld. For example the housing may have a form factor similar to a pager or a personal digital assistant, e.g., 6 to 12 centimeters (cm)×4 to 8 cm×1 to 3 cm. The housing 115 may be constructed of any rigid or semi-rigid material, including plastic, fiberglass, metal, or composites thereof.

In one embodiment the vehicle power adapter 120 is configured as a vehicle cigarette lighter plug that is integrated with the housing 115. The vehicle power adapter supplies power to the apparatus 110. In alternative embodiments the vehicle power adapter 120 may include a cord that is housed within the housing 115 and which can be extended from the housing for plugging into a vehicle cigarette lighter. In other alternative embodiments the vehicle power adapter 120 may be structured in other physical configurations for connecting with a power source (e.g., in a vehicle, building, or the like) having a power source receptacle, e.g., an alternating current (A-C) power receptacle or a cigarette lighter receptacle. In other alternative embodiments the power source may be a direct current (DC) power source, e.g., a battery or solar cell.

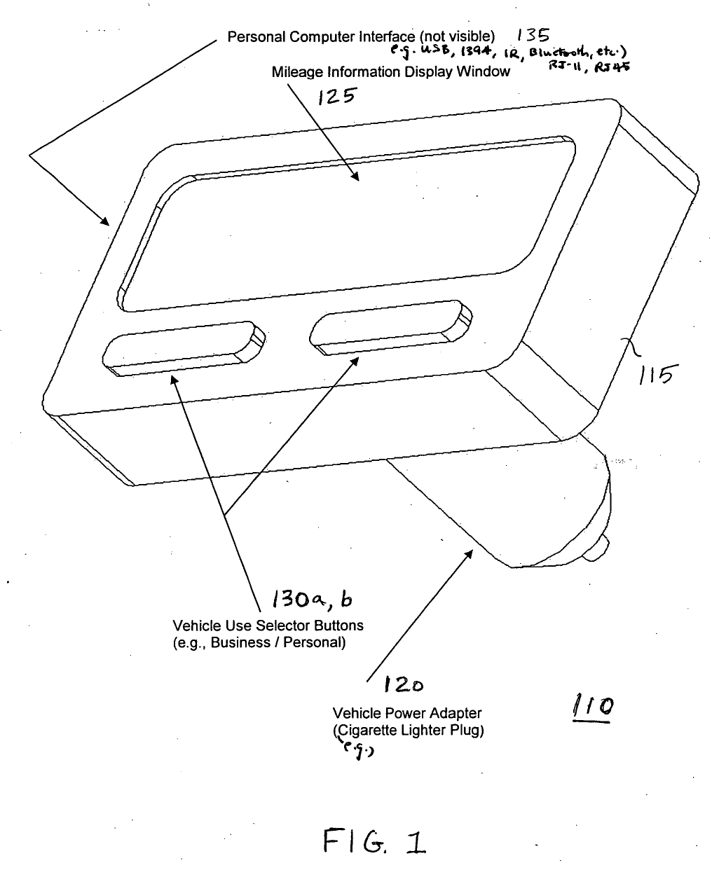

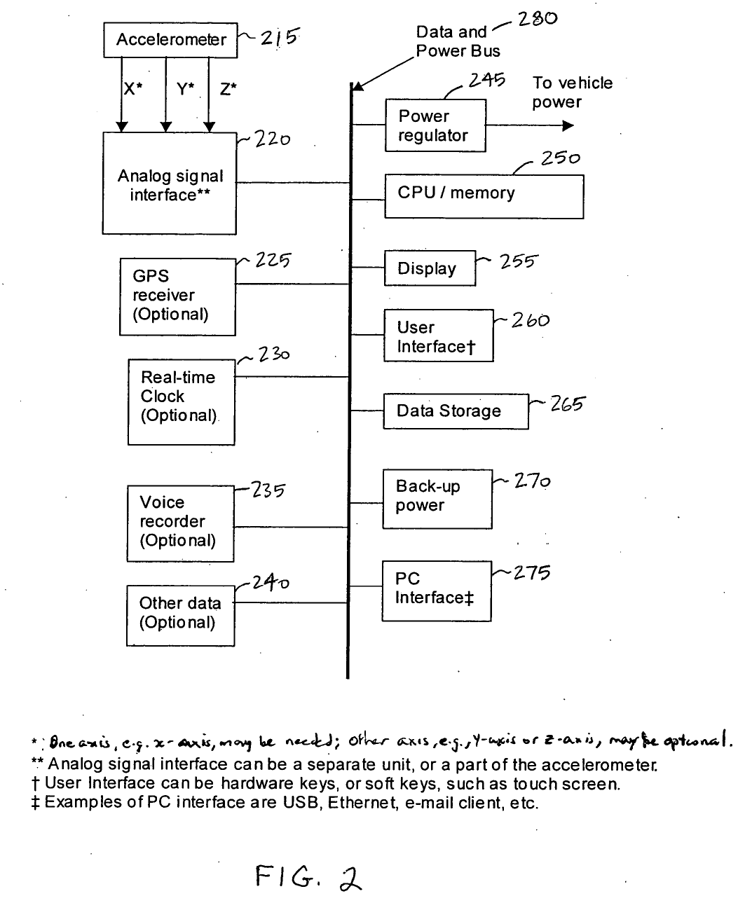

FIG. 2 illustrates one embodiment of a functional block diagram of a system 210 for mileage tracking apparatus 110 in accordance with the present invention. The system 210 includes a positional system, e.g., an accelerometer 215 or analog signal interface 220 and/or an optional global positioning system (GPS) receiver 225, a real time clock 230, an optional voice recorder 235, other optional data modules 240, a power regulator 245, a processor (CPU) and a memory 250, a display (e.g., a display driver) 255, a user interface 260, or data storage 265, a back-up power (optional) 270 and a personal computer (PC) interface 275. The components are coupled through a data and power bus 280. The accelerometer 215 is configured as a position sensor and is further described below.

The analog signal interface 220 is configured to convert analog signals from the accelerometer 215 into digital signals. The analog signal interface 220 may be configured as a separate component or may be integrated into the accelerometer 215. The GPS receiver 225 is optional and is configured to receive global positioning signals through the air. The GPS receiver 225 is further described below. The real-time clock 230 is used for date- and time-stamp each file. The date and time provides relevant timestamp information, e.g., for use in tax records. The optional voice recorder 235 is configured to capture voice (or other sound signals) for storage into the memory (250) or data storage 265.

The power regulator 245 is configured to couple a power source (e.g., vehicle power source) and provide appropriate power conversion functionality when applicable. The CPU/memory 250 are conventional processor or controller and memory components. The display 255 is a conventional display interface, for example, for a liquid crystal display (LCD), a plasma display, or a thin film display. The display 255 is a screen that may also be configured to accept input, e.g., as a touch sensitive or inductive positioning technology. The display 255 may be configured as a display window 125 that is integrated with the housing 115.

The user interface 260 includes keys and/or switches to allow a user to interact with the system. The keys may be QWERTY or reduced-QWERTY keys, directional keys or the like. The switches may be a jog dial, scroll wheel, pre-programmed buttons or the like, e.g., as illustrated in FIG. 1. In addition, the user interface may include a graphical and/or text display screen presentation. Further, the user interface 260 may be a touch screen configuration. The user interface 260 is further described below.

The PC (or other computer) interface 275 is a conventional computer communication interface such as USB, IEEE-1394, Ethernet, IEEE 802.11, e-mail client, Bluetooth and the like. The computer interface 275 is further described below. The data storage 265 is a conventional data storage such as magnetic disk, optical disk, flash-memory drive, or other non-volatile storage. The back-up power 270 is a conventional back-up power system such as battery or rechargeable power cells.

The mileage tracking apparatus 110 computes distance traveled by a vehicle based on one or More inertial position sensors, a Global Positioning System (GPS), or a combination of both. The inertial system is based on accelerometers, which gives acceleration of the vehicle. The acceleration can be integrated twice to give the distance the vehicle moved. The GPS gives absolute position, however, it is dependent on a GPS satellite constellation, and a GPS signal reception. Even if the GPS is integrated in the system, retaining an inertial system is preferred so that the accelerometer-based inertial system can “fill the gap” of GPS system when the GPS signal may not be available (e.g., the vehicle is traveling through a tunnel).

The user interface during the in-vehicle operation can be a one or two button(s)-(a) switch(es) or a touch sensor, to toggle the logging mode between “enable” and “not-enable”. It is noted that the device can also be configured so that logging can be enabled for more than one mode. The distance traveled, along with other information such as date, time, typed or voice memo, and the like, will be stored in an internal, non-volatile memory system (e.g., magnetic media, optical media, solid state, or other types of non-volatile storage system).

This information captured and stored by the mileage logger can be transferred to a user's computer by connecting the device to a computer via various industry standard connection methods. Examples of such connection methods include Universal Serial Bus (USB), Ethernet, IEEE 1394, IEEE 802.11, IEEE 802.16, Bluetooth and the like.

Once the device is communicatively connected to a computer, the user can initiate a download from the computer. The mileage logger can be configured so that it can be seen by the computer as an external disk drive, so that no special software is required on the user's computer to download the mileage information onto the computer. In addition, there can be automatic electronic mail (e-mail) integration using a conventional e-mail client. For example an e-mail transfer can be initiated automatically from the mileage logger 110, when the mileage logger 110 senses an available wireless network connections, such as IEEE 802.11a, b, g, or n when such optional hardware is implemented to the mileage logger 110 (e.g., when a vehicle is parked within a range of wireless hotspot, it automatically initiates an e-mail transfer). Moreover, the resulting file can be printed out, or read from software that the user prefers for record keeping or form completion (e.g., expense reports, tax form preparation).

In other alternative embodiments, the mileage logger may be integrated into a manufactured vehicle. Such systems may also be configured to be coupled with the vehicle electronics and have access to the vehicle's on board computer to obtain relevant data such as vehicle speed and/or the distance traveled. This configuration would also include an communication interface (wireless or wired) that would allow for downloading the data into a user's computer for use thereafter, e.g., record keeping, form completion, and the like. When the device configuration is optimized for the vehicle maintenance purpose, it is possible for service providers, e.g., auto manufacturers, dealers or maintenance shops, to receive periodic automatic e-mails from the device with the vehicle use data so that they can monitor the use of the vehicle to better schedule the maintenance and customer notifications.

Position Sensor

Inertial System

In one embodiment the mileage logger 110 is configured to integrate an accelerometer 215 that comprises micro electromechanical system (MEMS) accelerometers. Depending on the sophistication and level of accuracy desired, acceleration of the vehicle can be measured in one to three axes. A single axis system offers lowest cost, but a user typically will align the system (the sensor) with the travel direction of the vehicle. Misalignment may introduce an error in computation of the distance traveled. Additional accelerometers reduce or eliminate such errors. In some embodiments, using three accelerometers allows a user to install (or simply carry) the device in the vehicle oriented in any direction.

One embodiment of the mileage logger 110 uses numerical integration methods to integrate the acceleration in time once to obtain the vehicle speed, and integrate the velocity in time again to obtain the distance traveled. Conventional numerical integration algorithms are suitable for this type of integration. Moreover, the mileage logger 110 may be configured to minimize accumulated integration error to provide accurate readings.

In order to minimize the accumulated integration error, it is desirable to have a “self-initialization” capability. This automatic system can reset its velocity computation to zero in two ways. When the system is powered up, it initializes the velocity to zero. In embodiments of the mileage logger 110 configured with one or more accelerometers, the mileage logger 110 can be configured to sense vibration of the vehicle. When there is no vibration, and the sum of vectors is equal to the expected constant gravity vector, the mileage logger 110 can be preconfigured to assume that the vehicle is stopped, and therefore, it re-initializes the velocity to zero. With this on-the-fly (or real-time) initialization scheme, the accumulated integration error in the distance computation is de minimus and/or should be acceptable.

Global Positioning System

Alternative embodiments of a mileage logger 110 are configured with a GPS receiver 225 to obtain the distance traveled from the GPS data. The GPS receiver 225 provides absolute position of the vehicle at a given frequency. The distance can be computed from the GPS position information and summed up. In embodiments where position information from the GPS receiver 225 is dependent on the availability of the GPS signals, for example when a vehicle is traveling through a tunnel, a deep canyon, or GPS reception is inhibited by the terrain, the mileage logger 110 may also be configured to include an inertial system as a backup.

User Interface

The mileage logger 110 may be configured with a user interface 260 that allows for interaction and ease of use. The user interface 260 can be hardwired and/or mechanical, e.g., duals, buttons and/or switches, can be software, e.g., menus, selection windows, or can be a combination of hardwired or mechanical and software, e.g., scroll menu selection with a job dial and actuate the jog dial to make a selection. In one embodiment the user interface can be categorized in there phases: (1) initial setup, (2) in-vehicle operations, and (3) data download. The initial setup provides an interface to allow a user to initialize a mileage logger 110 for operation. Examples of initialization include preparing to capture data for a particular trip between a source and destination, allowing for trip information (e.g., name of trip and/or source/destination information) identifying whether data to be captured is for personal use or business use, identifying a vehicle and/or individual for which captured data will be associated and the like. The in-vehicle operation allows activity such as voice or other data entry rotations and storage, further configuration of data capture in view of changes made after initialization, noting and/or logging trip related information such as parking and toll fees and the like. The download data operation includes a user interface configured to download data through a wired or wireless connection to a destination device, for example, personal computer, laptop, or directly to a data storage medium as further described below.

All three phases may be configured in software (e.g., application software with a graphical user interface), in hardware (including firmware) (e.g., hardwired buttons for a particular function), or a combination of hardware and software. In addition, the in-vehicle operation phase may also include an additional user interface that provides simplicity and intuitiveness from the traffic safety standpoint, such as voice memo recording for each entry. It is noted that such interfaces can also be integrated into the other phases.

Data Storage

The mileage logger 110 may be configured to include a data storage device 265. The data storage device 265 may be a non-volatile storage device such as a magnetic disk drive, solid-state storage device, or the like. Alternatively, or additionally, the mileage logger may be configured to incorporate removable storage capability, for example, a CompactFlash® card, an XDCard, a USB thumbdrive, an optical disk, or the like. The small data storage devices may be configured to store data, for example, date/time, mileage data, vehicle usage and voice memo.

Computer Interface

The mileage logger 110 will have a means to communicate with a personal computer by an interface, e.g., a PC interface 275, that may be a wired connection, e.g., USB, serial, parallel or Ethernet network, or a wireless connection, e.g., Bluetooth. Some embodiments may be configured to include an integrated wireless network, e.g., IEEE 802.11.

Embodiments of the mileage logger 110 may also integrate an e-mail client with the network software. For example, when the mileage logger 110 includes an integrated wireless network, the mileage logger 110 may be configured to sense a stable wireless network signal (e.g., the car is parked near the office or home equipped with the wireless network, or any other commercial hot spot) and trigger the e-mail to send the log to a predetermined e-mail address. The predetermined e-mail address can be entered as a part of the initial device setup.

The mileage logger 110 can be configured for operation without any interaction with the operator of the vehicle operator. Since the mileage logger can be independent of the vehicle system it can even hidden from the vehicle operator. Such a device can provide back-up information in addition to the traditional odometer to prevent odometer fraud.

When the device includes its own internal battery, it can be used to track the mileage (also speed and acceleration—therefore the performance) of a vehicle without any electrical system or odometer, such as bicycles, or any other human and animal powered vehicle, as well as humans and animals themselves. In such a configuration the device can be used for sports training (for humans, race horses, and other animals).

It is also possible to include some additional sensors producing information such as medical and health information in the log. For example, a heart rate monitor integrated with the speed and distance traveled as well as acceleration, can be marketed to avid bicyclists, runners, and other athletes. It is also possible to monitor the patients with various medical conditions. Unlike the existing medical data logger, the device can log not only the resulting medical conditions (e.g., higher heart rate), but also the level of exercise that is the cause of the medical condition. Monitoring the vertical acceleration (i.e., the impact load) may be a very important factor for people and animals with certain medical conditions.

The mileage logger 110 advantageously provides an apparatus for more accurate mileage tracking and record keeping for vehicles and other things that move from a first location to a second location. Moreover, as noted above, the present invention is configured to include an inertial system, a GPS or a combination thereof providing accurate readings and back up capability. Further, the device can be configured to be self-contained, and hence, is portable for use with multiple vehicles and other moving things.

Operational Architecture

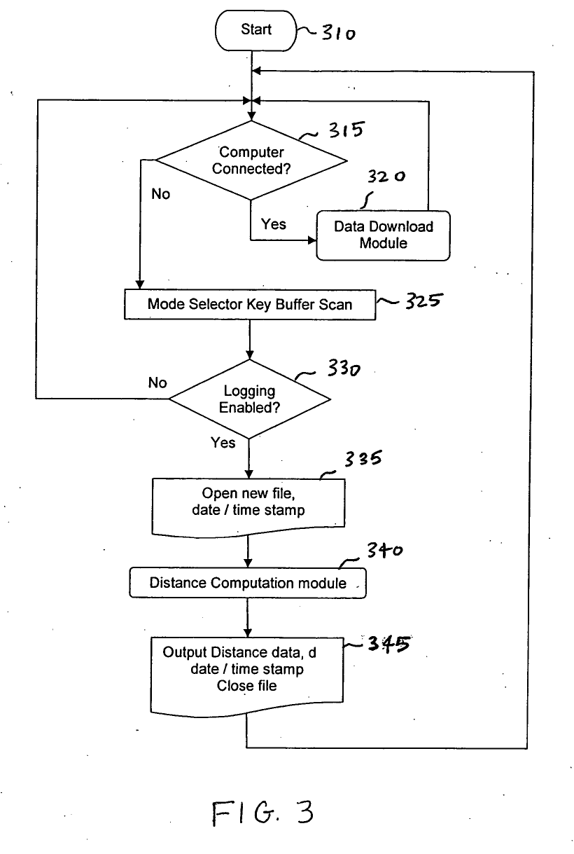

FIG. 3 illustrates one embodiment of a process for in-vehicle operation of a mileage logger 110 with a “logging enabled” key such as “business/personal” buttons. The process starts 310 and determines 315 whether a computer is connected to the mileage tracking apparatus. If a computer is connected, a data download module in the computer is configured to download 320 data from the mileage tracking apparatus. If no computer is connected, the process scans 325 a mode selector key buffer to determine which mode of operation has been selected, e.g., by a user. The process then determines 330 whether mileage logging is enabled. If it is not enabled, the process returns back to a start state. If it is enabled, the process opens 335 a new file and gives it a time and date stamp.

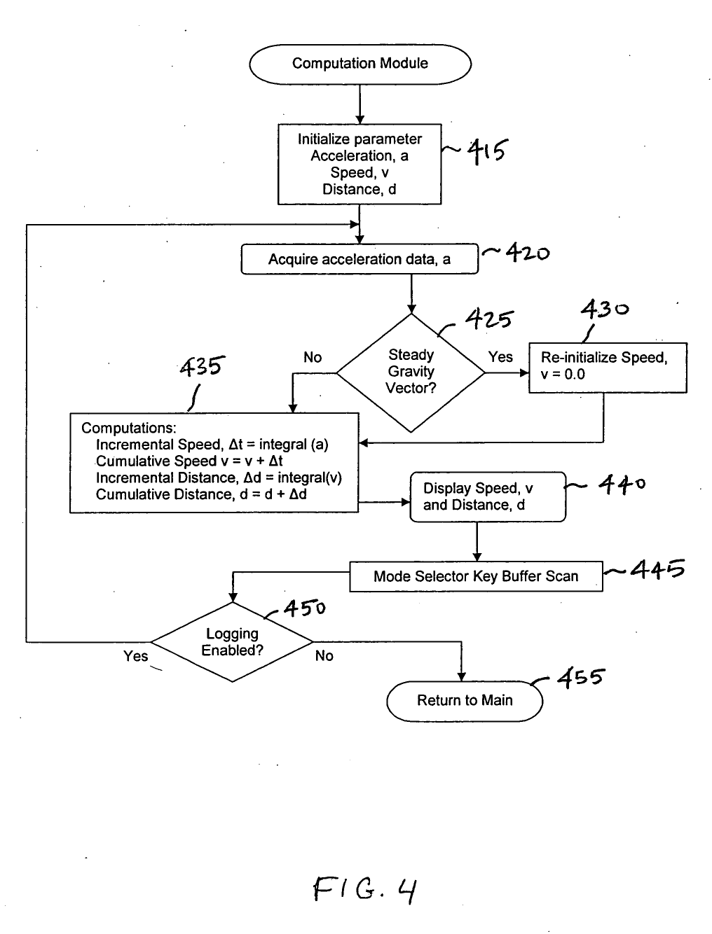

The process then uses a distance computation module to begin calculating 340 distance traveled. FIG. 4 illustrates one embodiment of a process for a distance computing module in accordance with the present invention. The process starts an initialize 415 parameters for acceleration (a), speed (v) and distance (d) within the software along with time information (e.g., date and start time as set through the clock 230). The process then has the accelerometer 215 acquire 420 acceleration data. The process determines 425 if a steady gravity vector is achieved. If so, the process reinitializes 430 speed. If not, or if speed has been reinitialized, the process computes 435 incremental speed, cumulative speed, incremental distance, and cumulative distance.

Once the computations are completed, the process displays 440 speed and distance on the display 255. It is possible to configure the process 440 to continuously send the speed and display to the computer interface as it updates the display. This allows the computer, if connected while the mileage logging is enabled, to receive the speed and distance data on real-time for whatever the purpose user may have. The process is configured to scan 445 the mode selection key buffer for any activity triggered by the user. For example, the process could determine 450 that logging was still enabled and begin acquiring acceleration data. If logging was not enabled, the process would return 455 to the main interface state, for example, as described in FIG. 3. Returning to FIG. 3, the process finally is configured to stop data gathering (e.g., stop time through clock 230) and output 345 distance data, date/time stamp information and the like before closing the file. This output data may be output from the data storage 265 once the mileage tracking apparatus connects 315 with a computer through the computer interface 275 and the data download module 320 begins downloading the data. As previously stated, the device looks like a storage device to a computer. The download can be initiated from the computer as if the user is copying a file from an external disk drive. It is further noted that the downloaded data can be sent directly to a software application or forms in a manner that allows for further data operations, e.g., completion of a trip expense form which may include preprogrammed information such as government set mileage deduction data and the like.

The present invention beneficially provides an apparatus for efficiently and accurately keeping track of trip related information for purposes that include business or personal use. Moreover, the device is configured so that the data may be output to other devices, forms, etc. to allow for reporting presentation, or further data operation. Further, because such data is automatically captured and transferred, the potential for errors in intermediary or manual steps is significantly reduced.

Upon reading this disclosure, those of skill in the art will appreciate still additional alternative structural and functional designs for a system and a process for a mileage tracking apparatus through the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. A distance measurement device comprising:
a housing structured for portability;
an interface structured with the housing and configured to allow data input to initialize and stop collection of travel data;
a position detection system structured within the housing and configured to determine travel data;
a timer configured to supply time stamp data corresponding to a start time and stop time;
a processor coupled with the position detection system and the timer to associate data with time stamp data and to format data for communication to an external device; and
a power supply configured to provide power to the position detection system, the timer, and the processor.

2. The device of claim 1, wherein the position detection system comprises an accelerometer.

3. The device of claim 1, wherein the position detection system comprises a global positioning system.

4. The device of claim 1, wherein the timer includes date data.

5. The device of claim 1, wherein the power supply couples an automobile cigarette lighter.

6. The device of claim 1, wherein the travel data comprises distance data.

7. The device of claim 4, further comprising a storage device for storing the travel data, the time data and the date data.

8. The device of claim 1, wherein the interface comprises selector buttons.

9. The device of claim 1, wherein the interface comprises a touch sensitive or inductive sensitive display.

10. A method of automatically tracking distance information for reporting purposes, the method comprising:
receiving an input to initialize an automated distance tracking mechanism and a clock;
starting the automated distance tracking mechanism to provide a first distance value;
stopping the automated distance tracking mechanism to provide a second distance value;
generating a total distance value corresponding to the difference between the first distance value and the second distance value;
applying a time and data stamp to the total distance value; and
formatting the data for use in a report.

11. The method of claim 10, wherein the automated distance tracking mechanism includes an accelerometer.

12. The method of claim 10, wherein the automated distance tracking mechanism includes a global positioning system receiver.

13. The method of claim 10, further comprising automatically transmitting the formatted data to another device.
